(19) United States
(12) Patent Application Publication
(10) Pub. No.: US 2026/0156464 A1
(43) Pub. Date: Jun. 4, 2026

(54) MEC-SERVICE SUBSCRIPTION SYNCHRONISATION IN ROAMING ARCHITECTURE

(71) Applicant: APPLE INC., Cupertino, CA (US)

(72) Inventors: Shu Guo, Beijing (CN); Haijing Hu, Los Gatos, CA (US); Dawei Zhang, Saratoga, CA (US); Walter Featherstone, Cirencester (GB); Mona Agnel, Guildford (GB)

(21) Appl. No.: 19/122,959

(22) PCT Filed: Nov. 7, 2022
(86) PCT No.: PCT/CN2022/130310

§ 371 Date: Apr. 21, 2025

(51) Int. Cl. H04W 12/06; H04W 12/041; H04W 12/0433; H04W 12/72

(52) U.S. Cl. CPC H04W 12/06; H04W 12/041; H04W 12/0433; H04W 12/72

(57) ABSTRACT

A user equipment (UE) may be configured to subscribe to one or more authentication mechanisms supported by the UE. The UE may generate key identifiers for the one or more authentication mechanisms supported by the UE. The UE may send a request to an edge configuration server (ECS). The request may comprise the one or more authentication mechanisms supported by the UE, and the key identifiers to indicate to the ECS that the UE is subscribed to the one or more authentication mechanisms.

### TECHNICAL FIELD

This application relates generally to wireless communication systems, including authentication procedures for edge networks.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an architecture for enabling edge applications according to various exemplary embodiments.

FIG. 2 illustrates a signal diagram for deriving an Authentication and Key Management for Applications (AKMA) anchor key (K_{AKMA}) in accordance with some embodiments.

FIG. 3 illustrates a signal diagram for AKMA Application Key (K_{AF}) generation from K_{AKMA} in accordance with some embodiments.

FIG. 4 illustrates a signal diagram for an authentication procedure for Authentication and Key Agreement (AKA) in accordance with some embodiments.

FIG. 5 illustrates a signal diagram for a negotiation procedure for a UE and the network to determine a mechanism for a subsequent authentication procedure in accordance with some embodiments.

FIG. 6 illustrates an example architecture of a wireless communication system, according to embodiments disclosed herein.

FIG. 7 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Some exemplary embodiments are also described with regard to a fifth generation (5G) New Radio (NR) network. However, reference to a 5G NR network is merely provided for illustrative purposes. The exemplary embodiments may be utilized with any network that allows the UE to access an edge data network.

In some embodiments, the UE may access the edge data network via the 5G NR network. The edge data network may provide the UE with access to edge computing services. Those skilled in the art will understand that edge computing refers to performing computing and data processing at the network where the data is generated. In contrast to legacy approaches that utilize a centralized architecture, edge computing is a distributed approach where data processing is localized towards the network edge, closer to the end user. This allows performance to be optimized and latency to be minimized.

An Edge Configuration Server (ECS) may provide supporting functions for the Edge Enabler client to connect with an Edge Enabler Server. Functionalities of an Edge Configuration Server may comprise provisioning of Edge configuration information to the Edge Enabler Client (EEC). The Edge configuration information may include the information for the EEC to connect to the Edge Enabler Server (e.g. service area information applicable to local area data network (LADN)); and the information for establishing a connection with Edge Enabler Servers (e.g., uniform resource identifier (URI)).

The EEC may provide supporting functions for Application Client(s). Functionalities of Edge Enabler Client may include retrieval and provisioning of configuration information to enable the exchange of Application Data Traffic with the Edge Application Server; and discovery of Edge Application Servers available in the Edge Data Network. Additionally, an EEC ID is a globally unique value that identifies the EECs. One or more EEC(s) may be located in a UE.

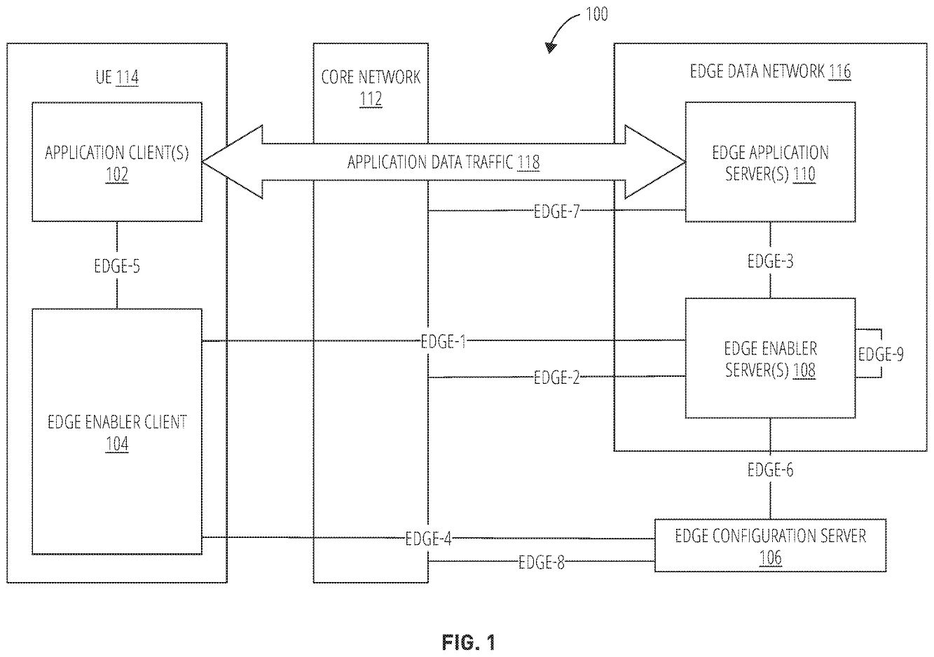

FIG. 1 shows an architecture 100 for enabling edge applications according to various exemplary embodiments. The architecture 100 includes the UE 114, the core network 112 and the edge data network 116. The UE 114 may establish a connection to the edge data network 116 via the core network 112 and various other components.

The edge data network 116 is a local data network. Edge Application Server(s) (EAS 110) and the Edge Enabler Server (EES 108) are contained within the edge data network 116. The Edge Configuration Server (ECS 106) provides configurations related to the EES 108, including details of the Edge Data Network 116 hosting the EES 108. The UE 114 contains Application Client(s) (AC 102) and the Edge Enabler Client (EEC 104). The EAS 110, the EES 108, and the ECS 106 may interact with the Core Network 112.

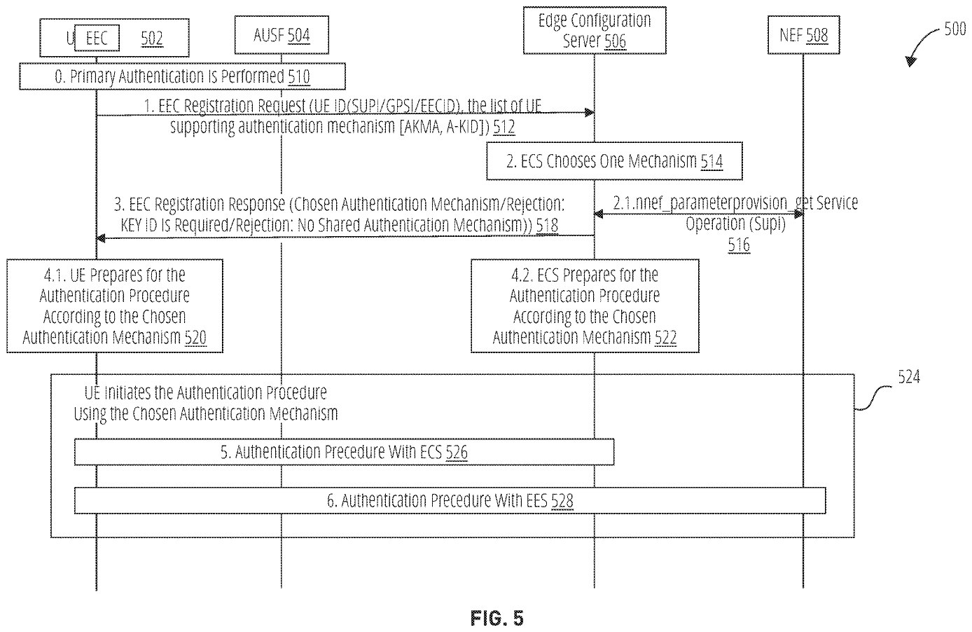

The exemplary embodiments herein will be described with regard to a negotiation procedure for determining which authentication procedure is to be utilized to enable the UE 114 to access to the edge data network 116. Successful completion of the exemplary negotiation procedure may precede the flow of application data traffic 118 between the edge data network 116 and the UE 114. The architecture 100 provides a general example of the type of components that may interact with one another for enabling edge applications. Specific examples of the exemplary negotiation procedures will be provided below with regard to the signaling diagrams of FIG. 5.

In the architecture 100, the various components are shown as being connected via reference points labeled edge-x (e.g., edge-1, edge-2, edge-3, edge-4, edge-5, edge-6, edge-7, edge-8, etc.). Those skilled in the art will understand that each of these reference points (e.g., connections, interfaces, etc.) are defined in the 3GPP Specifications. In this description, these reference points may be used in the manner in which they are defined in the 3GPP Specifications and may be modified in accordance with the exemplary embodiments described herein. Furthermore, while these interfaces are termed reference points in this description, those skilled in the art will understood that these interfaces are not required to be direct wired or wireless connections, e.g., the interfaces may communicate via intervening hardware and/or software components. To provide an example, the UE 110 may exchange signals over the air with a network node. However, in the architecture 100 the UE 110 is shown as having a direct connection to the ECS 106. Those skilled in the art will understand that this connection is not a direct communication link between the UE 110 and the ECS 106. Instead, this is a connection that is facilitated by intervening hardware and software components. Thus, throughout this description the terms “connection,” “reference point” and “interface” may be used interchangeably to describe the interfaces between the various components in the architecture 100 and the network arrangement.

During operation, application data traffic 118 may flow between the AC 102 running on the UE 114 and the EAS 110 of the edge data network 116. The EAS 110 may be accessed through the core network 112 via uplink classifiers (CL) and branching points (NP) or in any other appropriate manner. Those skilled in the art will understand the variety of different types of operations and configurations relevant to an application client and an EAS. The operations performed by these components are beyond the scope of the exemplary embodiments. Instead, these components are included in the description of the architecture 100 to demonstrate that the exemplary negotiation procedure may precede the flow of application data traffic 118 between the UE 114 and the edge data network 116.

The EEC 104 may be configured to provide supporting functions for the AC 102. For example, the EEC 104 may perform operations related to concepts such as, but not limited to, the discovery of EASs that are available in an edge data network (e.g., EAS 110) and the retrieval and provisioning of configuration information that may enable the exchange of the application data traffic 118 between the AC 102 and the EAS 110. To differentiate the EEC 104 from other EECs, the EEC 104 may be associated with a globally unique value (e.g., EEC ID) that identifies the EEC 104. Further, reference to a single AC 102 and EEC 104 is merely provided for illustrative purposes, the UE 114 may be equipped with any appropriate number of application clients and EECs.

The edge data network 116 may also include an EES 108. The EES 108 may be configured to provide supporting functions to the EAS 110 and the EEC 104 running on the UE 114. For example, the EES 108 may perform operations related to concepts such as, but not limited to, provisioning configuration to enable the exchange of the application data traffic 118 between the UE 114 and the EAS 110 and providing information related to the EAS 110 to the EEC 104 running on the UE 114. Those skilled in the art will understand the variety of different types of operations and configurations relevant to an EES. Further, reference to the edge data network 116 including a single EAS 110 and a single EES 108 is merely provided for illustrative purposes. In an actual deployment scenario, an edge data network may include any appropriate EASs and EESs interacting with any number of UEs.

The ECS 106 may be configured to provide supporting functions for the EEC 104 to connect the EES 108. For example, the ECS 106 may perform operations related to concepts such as, but not limited to, provisioning of edge configuration information to the EEC 104. The edge configuration information may include the information for the EEC 104 to connect to the EES 108 (e.g., service area information, etc.) and the information for establishing a connection with the EES 108 (e.g., uniform resource identifier (URI)). Those skilled in the art will understand the variety of different types of operations and configurations relevant to an ECS.

In the architecture 100, the ECS 106 is shown as being outside of the edge data network 116 and the core network 112. In addition, the EAS 110 and the EES 108 are shown as being inside of the edge data network 116. However, these examples are merely provided for illustrative purposes. The EAS 110, the EES 108 and the ECS 106 may be deployed in any appropriate virtual and/or physical location (e.g., within the mobile network operator's domain or within a third-party domain) and implemented via any appropriate combination of hardware, software and/or firmware.

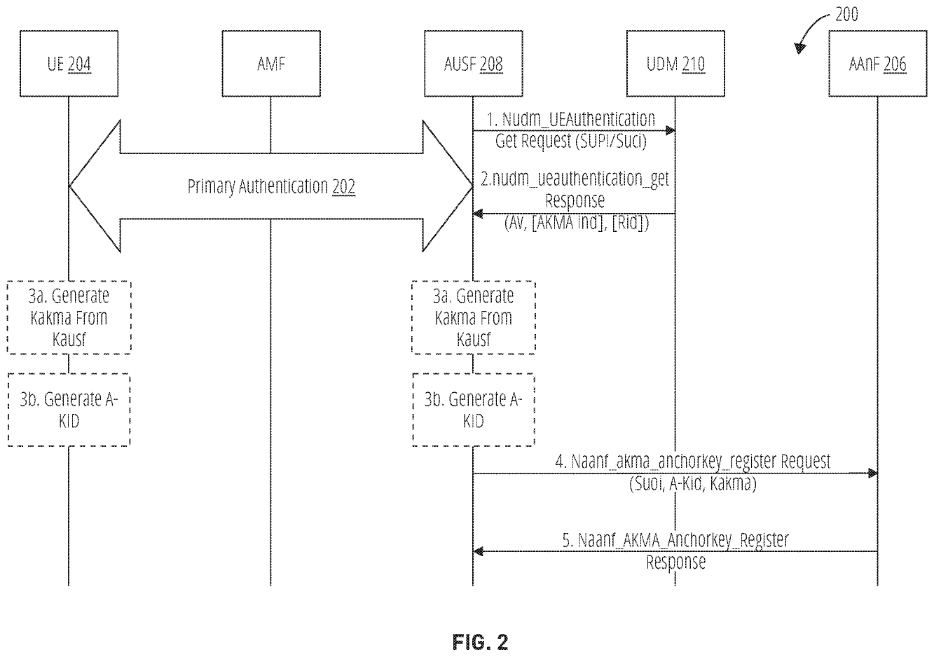

FIG. 2 illustrates a signal diagram 200 for deriving an Authentication and Key Management for Applications (AKMA) anchor key (K_{AKMA}) after a primary authentication 202. AKMA is based on primary authentication 202, UE 204 and AKMA Anchor Function (AAnF 206) will share the K_{AKMA} and AKMA Key Identifier (A-KID).

During the primary authentication 202 procedure, the Authentication Server Function (AUSF 208) interacts with the Unified Data Management (UDM 210) in order to fetch authentication information such as subscription credentials (e.g. Authentication and Key Agreement (AKA) Authentication vectors) and the authentication method using the Nudm_UEAuthentication_Get Request service operation.

In the response, the UDM 210 may also indicate to the AUSF 208 whether the AKMA Anchor key needs to be generated for the UE 204. If the AKMA indication is included, the UDM 210 shall also include the RID of the UE 114.

If the AUSF 208 receives the AKMA indication from the UDM 210, the AUSF 208 shall store the AUSF key (K_{AUSF}) and generate the K_{AKMA} and the A-KID from K_{AUSF} after the primary authentication procedure is successfully completed.

The UE 204 may generate the K_{AKMA} and the A-KID from the K_{AUSF} before initiating communication with an AKMA Application Function.

After AKMA key material is generated, the AUSF 208 may select the AAnF 206, and send the generated A-KID and K_{AKMA} to the AAnF 206 together with the Subscription Permanent Identifier (SUPI) of the UE 204 using the Naanf_AKMA_KeyRegistration Request service operation. The AAnF 206 may store the latest information sent by the AUSF 208.

The AAnF 206 may send the response to the AUSF 208 using the Naanf_AKMA_AnchorKey_Register Response service operation. A-KID may identify the K_{AKMA} key of the UE.

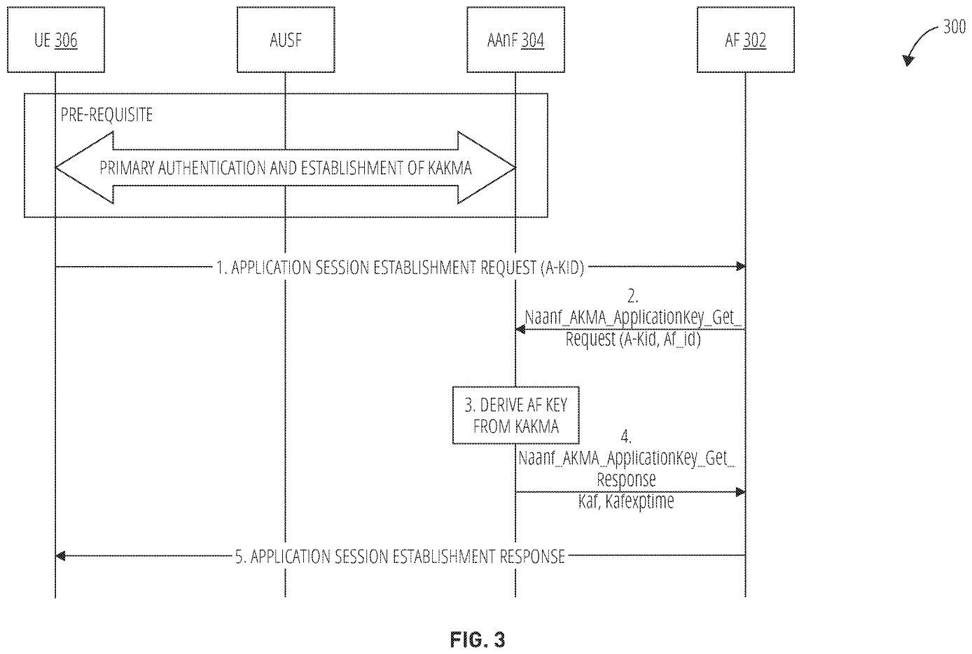

FIG. 3 illustrates a signal diagram 300 for AKMA Application Key (K_{AF}) generation from K_{AKMA}. In some embodiments, K_{AF} is derived based on K_{AKMA}. Application Function (AF 302) derives K_{AF}. There is no Network Exposure Function (NEF) between AAnF 206 and AF 302, and the timing of the UE 306 deriving K_{AF} is flexible.

The procedure may be used by the AF 302 to request application function specific AKMA keys from the AAnF 206, when the AF 302 is located inside the operator's network. Before communication between the UE 306 and the AKMA AF 302 can start, the UE 114 and the AKMA AF 302 may determine whether to use AKMA. This knowledge may be implicit to the specific application on the UE 306 and the AKMA AF 302 or indicated by the AKMA AF 302 to the UE 306.

The UE 306 may generate the K_{AKMA} and the A-KID from the K_{AUSF} before initiating communication with an AKMA AF 302. When the UE 306 initiates communication with the AKMA AF 302, it may include the derived A-KID in the Application Session Establishment Request message. The UE 306 may derive K_{AF} before sending the message or afterwards.

If the AF 302 does not have an active context associated with the A-KID, then the AF 302 may select the AAnF 304 and send a Naanf_AKMA_ApplicationKey_Get request to AAnF 304 with the A-KID to request the K_{AF} for the UE 306. The AF 302 also includes its identity (AF_ID) in the request. AF_ID may comprise the fully qualified domain name (FQDN) of the AF 302 and the Ua* security protocol identifier. The latter parameter identifies the security protocol that the AF 302 will use with the UE 602. The AAnF 304 may check whether the AAnF 304 can provide the service to the AF 302 based on the configured local policy or based on the authorization information available in the signaling (i.e., Oauth2.0 token). If it succeeds, the following procedures may be executed. Otherwise, the AAnF 304 may reject the procedure. The AAnF 304 may verify whether the subscriber is authorized to use AKMA based on the presence of the UE 306 specific K_{AKMA} key identified by the A-KID. If K_{AKMA} is present in AAnF 304, the AAnF 304 may continue with step 3. If K_{AKMA} is not present in the AAnF 304, the AAnF 304 may continue with step 4 with an error response.

In step 3, the AAnF 304 derives the K_{AF} from K_{AKMA} if it does not already have K_{AF}.

In step 4, the AAnF 304 sends Naanf_AKMA_ApplicationKey_Get response to the AF 302 with SUPI, K_{AF} and the K_{AF} expiration time.

In step 5, the AF 302 sends the Application Session Establishment Response to the UE 306. If the information in step 4 indicates failure of AKMA key request, the AF 302 shall reject the Application Session Establishment by including a failure cause. Afterwards, UE 306 may trigger a new Application Session Establishment request with the latest A-KID to the AKMA AF.

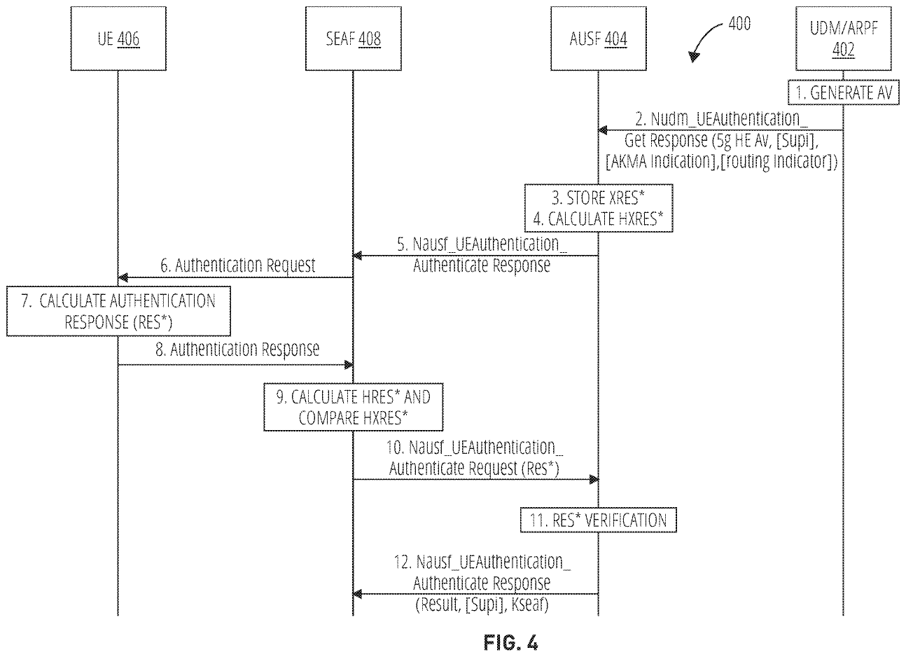

FIG. 4 illustrates a signal diagram 400 for an authentication procedure for AKA. In step 1, for each Nudm_Authenticate_Get Request, the UDM/ARPF 402 may create an Authentication Vector (AV). The UDM/ARPF 402 may do this by generating an AV with the Authentication Management Field (AMF) separation bit set to “1.” The UDM/ARPF 402 may then derive K_{AUSF}, and calculate XRES*. Finally, the UDM/ARPF 402 may create a 5G HE AV from RAND, AUTN, XRES*, and K_{AUSF}.

In step 2, the UDM/ARPF 402 may then return the 5G HE AV to the AUSF 404 together with an indication that the 5G HE AV is to be used for 5G-AKA in a Nudm_UEAuthentication_Get Response. In case SUCI was included in the Nudm_UEAuthentication_Get Request, UDM/ARPF 402 may include the SUPI in the Nudm_UEAuthentication_Get Response. In step 2, if a subscriber has an AKMA subscription, the UDM may include the AKMA indication and Routing indicator in the Nudm_UEAuthentication_Get Response.

In step 3, the AUSF 404 may store the XRES* temporarily together with the received SUCI or SUPI. The AUSF 404 may store the K_{AUSF}. In step 4, the AUSF 404 may then generate the 5G AV from the 5G HE AV received from the UDM/ARPF by computing the HXRES* from XRES* and KSEAF from K_{AUSF}, and replacing the XRES* with the HXRES* and K_{AUSF} with KSEAF in the 5G HE AV. In step 5 the AUSF 404 may then remove the KSEAF return the 5G SE AV (RAND, AUTN, HXRES*) to the SEAF 408 in a Nausf_UEAuthentication_Authenticate Response.

In step 6, the SEAF 408 may send RAND, AUTN to the UE 406 in a message Authentication-Request. In step 7, at receipt of the RAND and AUTN, the USIM shall verify the freshness of the AV by checking whether AUTN. In step 8, the UE 406 may send an authentication response to the SEAF 408. In step 9, the SEAF 408 may compute HRES*, and the SEAF shall compare HRES* and HXRES*. If they coincide, the SEAF 408 shall consider the authentication successful from the serving network point of view. In step 10, the SEAF 408 shall send RES* together with the corresponding SUCI or SUPI, as received from the UE, in a Nausf_UEAuthentication_Authenticate Request message to the AUSF. In step 11, when the AUSF 404 receives the Nausf_UEAuthentication_Authenticate Request message including a RES* it may determine whether the AV has expired. In step 12, the AUSF 404 shall indicate to the SEAF 408 in the Nausf_UEAuthentication_Authenticate Response whether the authentication was successful or not from the home network point of view.

As mentioned previously, the exemplary embodiments herein introduce enhancements for negotiation of authentication procedures for edge networks. A first issue involved in edge networks includes subscription synchronization between a UE and an ESC. That is, there is currently not an efficient way to ensure that the subscription information is synched between UE, ESC, and Home Public Land Mobile Network (HPLMN). The UE/USIM might not subscribed to the AKMA/generic bootstrapping architecture (GBA) service, in that case, then the AKMA is not available for the UE. There exists a need for the network to be able to efficiently check the UE's subscription on each service.

A second issue involved in edge networks includes how to consider the HPLMN's capability (e.g., supported mechanism in HPLMN) during the negotiation procedure. Some solutions use configurational way to provision HPLMN capability. For example an ECS may be configured with HPLMN's capability before the negotiation procedure. The ECS can be deployed in the mobile network operator (MNO) domain or can be deployed in third party domain by service provider. HPLMN authentication capability can be provisioned into ECS. But there is always possibility that ECS has no information on some operator's authentication capability, in which case a dynamic HPLMN authentication capability fetching procedure is needed.

Some enhancements proposed to address this second issue have resulted in additional concerns. For example, adding a new NEF service is not practical. Further, it is not clear how the ECS finds the HPLMN NEF end point. Additionally, if invoking such service may not be individual UE oriented, then it may not be desirable to be tied with EEC registration procedure. Accordingly, a new solution is needed to address this issue.

Described herein are embodiments to address both issues described above. In some embodiments, the UE may implicitly indicate a UE subscription by including a key ID in the negotiation process. For example, the UE can include the SUPI, Key ID of each authentication capability in an EEC registration request. During the primary registration, if a subscriber has an AKMA subscription, the UDM may include the AKMA indication and Routing indicator in the Nudm_UEAuthentication_Get Response as shown in FIG. 2. In the AKMA procedure, a UE may generate the K_{AKMA} and the A-KID from the K_{AUSF} (as shown in FIG. 2) before initiating communication with an AKMA Application Function. This indicates that UE can generate A-KID right after primary authentication or just before it determines to use AKMA service. Embodiments herein may include a UE that derives the K_{AKMA} and the A-KID before it starts the negotiation procedure in Multi-access edge computing (MEC). This could also implicitly indicate that the UE has subscribed with AKMA.

For example, if the UE supports AKMA, and it has already derived the K_{AKMA} with the HPLMN, then the UE may indicate to the network using [AKMA, A-KID] in the EEC registration request as shown in FIG. 5. For GBA, the UE may include [GBA, B-TID] in the registration request.

In accordance with some embodiments, the UE and ECS may have enhancements to provide support in case of an authentication failure. In cases where the UE does not provide Key ID of AKMA/GBA for some reason (e.g., no Key ID in the EEC registration request), the ECS may not have information on the HPLMN capability. In these cases, the ECS may have two options. In a first option, the ECS may reject the authentication request and indicate the reason in a rejection message. For example, the rejection message may inform the UE that a key ID is required. After the rejection, the ECS may update the stored HPLMNs' edge authentication capability to add the authentication capability of this HPLMN. In a second option, the ECS may route a message back to NEF of UE's HPLMN based on SUPI.

FIG. 5 illustrates a signal diagram 500 for a negotiation procedure for a UE 502 and the network to determine a mechanism for a subsequent authentication procedure 524. The negotiation procedure features the enhancements discussed above, including a SUPI and Key ID in the EEC request, as well as enhancements to the handling of authentication failure. The signaling diagram 500 includes the UE 502, the AUSF 504, the ECS 506, and the NEF 508.

A primary authentication 510 may be performed. The primary authentication 510 may be performed between the UE 502 and network functions such as, but not limited to, the AUSF 504. Subsequently, the UE 502 is successfully registered into the network. After primary authentication 510 is performed, the UE 502 may initiate the negotiation procedure with the ECS 506.

The UE 502 may send an EEC registration request 512 message to the ECS 506. The EEC registration request 512 may include a list of authentication mechanisms supported at the UE 502 and also UE ID. The list of authentication mechanisms potential authentication mechanism include TLS with AKMA, TLS with GBA, TLS with certificate/one-way TLS, or other potential mechanisms. These example authentication mechanisms are merely provided for illustrative purposes, the exemplary embodiments may apply to any appropriate number or type of authentication mechanisms.

There might be cases where the UE 502 is capable AKMA or GBA, however it is not subscribed. The operator may therefore desire to check the subscription status when the UE indicates it is capable via the EEC registration request 512. The negotiation procedure may be enhanced for the UE 502 to provide subscription information via the EEC registration request 512. For example, for AKMA capability, UE 502 may include [“AKMA”, A-KID] in the EEC registration request 512. A-KID may be generated as shown in FIG. 2. For GBA, UE 502 may include [“GBA”, Bootstrapping Transaction Identifier (B-TID)] in the EEC registration request 512. TLS with certificate/one-way TLS does not require subscription. The EEC registration request 512 may also include parameters such as, but not limited to, a UE ID, a SUPI, a generic public subscription identifier (GPSI), an EEC ID, etc. These identifiers may enable the edge network components (e.g., ECS, EES, etc.) and/or core network components (e.g., NEF, etc.) to find a routing to the UE 110 deployed in the current PLMN.

By including the SUPI and Key ID of each authentication capability in the EEC registration request 512, the UE 502 may implicitly indicate the UE subscription. The identifiers in EEC registration request 512 may enable the edge network components (e.g., ECS, EES, etc.) and/or core network components (e.g., NEF, etc.) to find a routing to the UE 502 deployed in the current PLMN.

The ECS 506 may determine from the request the one or more authentication mechanisms support by the UE and to which authentication mechanisms the UE is subscribed. The ECS 506 may selects 514 one of the authentication mechanisms included in the list of UE supported authentication mechanisms provided by the UE 502 in EEC registration request 512 based on local policy. In case the ECS 506 prefers to use AKMA, the ECS 506 may check with NEF 508 whether the current K_{AF} is still valid using the Nnef_AKMA_ApplicationKey_Get service (A-KID, AF-ID), NEF 508 will response with K_{AF} and K_{AF} expiration time, as described in Technical Specification (TS) 33.535. In some embodiments, if the UE 502 didn't include a Key ID in the registration request, the ECS 506 may use the Nnef_ParameterProvision_Get service operation 516 to fetch HPLMN's capability on MEC authentication. As shown, the Nnef_ParameterProvision_Get service operation 516 may use SUPI. The ECS 506 may route the service operation to the NEF 508 of the HPLMN of the UE to obtain missing key identifiers based on the SUPI. The Nnef_ParameterProvision_Get service operation 516 may take place before or after the ECS 506 selects an authentication mechanism.

A Nnef_ParameterProvision_Get service operation 516 may be used to request the HPLMN capability information from the NEF 508. The Nnef_ParameterProvision_Get service may be enhanced for the retrieval of HPLMN capability information. An example of this is shown below. However, the exemplary embodiments are not limited to the non-limiting examples provided above and may utilize any appropriate type of signal for this request.

Nnef_ParameterProvision_Get service operation

Service operation name: Nnef_ParameterProvision_Get
Description: The consumer gets the UE related information (e.g. Expected UE
Behaviour, Network Configuration parameters, ECS Address Configuration Information,
HN capability of authentication mechanisms).
Inputs, Required: GPSI, AF Identifier, EEC ID/SUPI, requested information (e.g.,
Expected UE Behaviour, Network Configuration parameters, ECS Address Configuration
Information).
Inputs, Optional: None.
Outputs, Required: Requested data, Operation execution result indication.
Outputs, Optional: None.

This service operation may be sent by a network node (e.g., ECS 506) to an NEF. In response to the exemplary service operation, the consumer (e.g., ECS 506, network function, etc.) may receive UE related information such as, but not limited to, expected UE behavior, network configuration parameters, ECS address configuration information and HPLMN capability information indicating which authentication mechanisms are supported by the HPLMN of the UE. The input parameters of the exemplary Nnef_ParameterProvision_Get service operation may include GPSI, an AF identifier, an EEC ID, SUPI, and an indication of the requested information (e.g., expected UE behavior, network configuration parameters, ECS address configuration information, etc.). Those skilled in the art will understand that the EEC ID is a globally unique ID that identifies an EEC. This may enable the NEF is able to find the correct routing according to the EEC ID. The SUPI may provide the NEF with a unique identifier for each Subscriber.

Returning to the signaling diagram 500, during the Nnef_ParameterProvision_Get service operation 516, the NEF 508 may request HPLMN capabilities for authentication from the NEF 508 of the HPLMN. The request may include an identifier for the UE 502 and/or EEC (e.g., UE ID, GPSI, EEC ID, SUPI, etc.). The NEF 508 may return the HPLMN capabilities for authentication. For example, the NEF 508 may indicate whether TLS with AKMA, TLS with GBA, TLS with certificate and/or any other appropriate mechanism is supported by the PLMN.

The ECS 506 may send an EEC registration response 518 to the UE 502. The application registration response may include the authentication mechanisms selected by the ECS 506 and any other appropriate type of information. Reference to the terms “application registration request” and “application registration response” are provided for illustrative purposes. Different entities may refer to similar messages by a different name.

In some embodiments, if the UE 502 provides no Key ID of AKMA/GBA in the EEC registration request 512, the EEC registration response 518 registration response may include a reject message, a cause code, an error code and/or any other appropriate type of indication that the UE 502 application registration request has been rejected. For example, the ECS may generate and send a rejection if the request includes an authentication mechanism without an associated key identifier that indicates that key identifiers are required. For instance, if the ECS 506 rejected the registration request, the reject reason may be included in the response message (e.g., EEC registration response 518). The rejection reason may include: reason #1: Key ID is required; reason #2: no shared authentication mechanism; and reason #3: the key is expired. If the ECS 506 rejected UE 502 EEC registration request 512 using reason #1, the ECS 506 may update its configuration information on this HPLMN.

In response to the EEC registration response 518, the UE 502 prepares 520 for the selected authentication procedure. For example, the UE 502 may generate AKMA keys, GBA keys, certificates or any other appropriate type of information that are to be used in the selected authentication procedure. In other embodiments, the UE 502 may prepare for supported authentication procedures prior to the reception of the application registration request or at any other appropriate time. If the UE 502 received the registration rejection message with reason #1, the UE 502 may perform the corresponding procedure to fetch the key ID. The UE 502 may send another EEC registration request with the key ID.

The ECS 506 may also prepare 522 for the selected authentication procedure. For example, after sending the EEC registration response 518, the ECS 506 or any other appropriate component may generate AKMA keys, GBA keys, certificates or any other appropriate type of information that is to be used in the selected authentication procedure.

The UE 502 performs the selected authentication procedure 526 with the ECS 506. The UE 502 also performs an authentication procedure 528 with the EES. In some embodiments, the authentication procedure performed between the UE 502 and the EES may be the selected authentication procedure, e.g., the same authentication procedure performed between the UE 502 and the ECS 506. Thus, the exemplary negotiation procedure described herein may be applicable to multiple different authentication procedures. However, the exemplary embodiments are not required to be used for multiple different authentication procedures. The exemplary negotiation procedure described herein may be used to select an authentication mechanism for any appropriate number of one or more different authentication procedures.

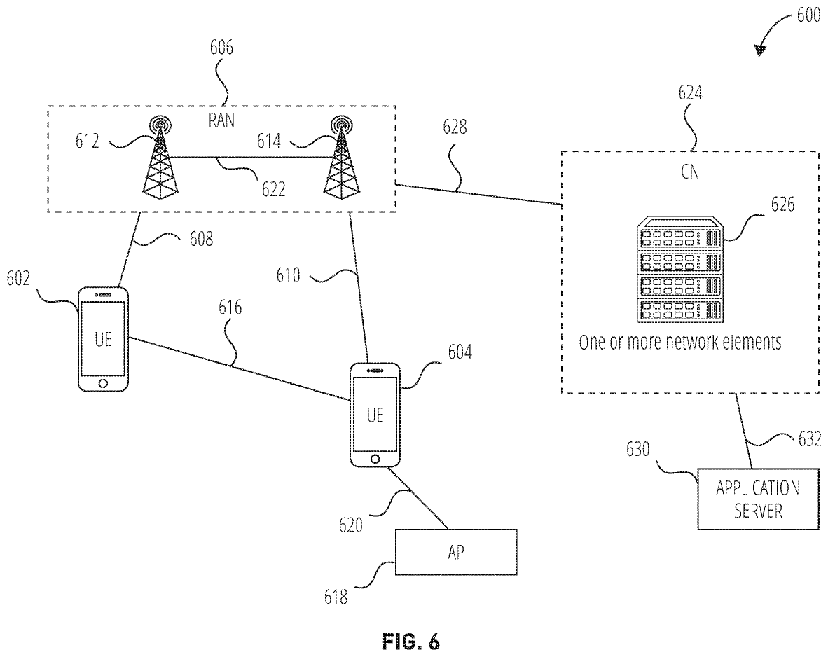

FIG. 6 illustrates an example architecture of a wireless communication system 600, according to embodiments disclosed herein. The following description is provided for an example wireless communication system 600 that operates in conjunction with the LTE system standards and/or 5G or NR system standards as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks), but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more base stations (such as base station 612 and base station 614) that enable the connection 608 and connection 610.

In this example, the connection 608 and connection 610 are air interfaces to enable such communicative coupling, and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 802.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more base stations (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more base stations (e.g., two or more gNBs and the like) that connect to 5GC, between a base station 612 (e.g., a gNB) connecting to 5GC and an eNB, and/or between two eNBs connecting to 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a user plane function (UPF), and the S1 control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VoIP sessions, group communication sessions, etc.) for the UE 602 and UE 604 via the CN 624. The application server 630 may communicate with the CN 624 through an IP communications interface 632.

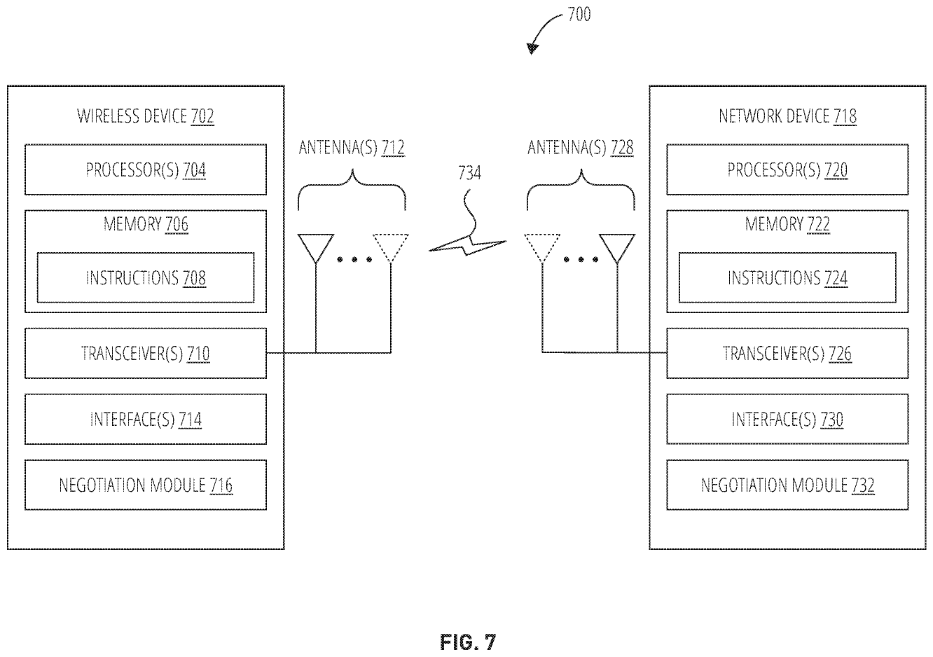

FIG. 7 illustrates a system 700 for performing signaling 734 between a wireless device 702 and a network device 718, according to embodiments disclosed herein. The system 700 may be a portion of a wireless communications system as herein described. The wireless device 702 may be, for example, a UE of a wireless communication system. The network device 718 may be, for example, an edge configuration server.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 that may include radio frequency (RF) transmitter and/or receiver circuitry that use the antenna(s) 712 of the wireless device 702 to facilitate signaling (e.g., the signaling 734) to and/or from the wireless device 702 with other devices (e.g., the network device 718) according to corresponding RATs.

The wireless device 702 may include one or more antenna(s) 712 (e.g., one, two, four, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth®, and the like).

The wireless device 702 may include a negotiation module 716. The negotiation module 716 may be implemented via hardware, software, or combinations thereof. For example, the negotiation module 716 may be implemented as a processor, circuit, and/or instructions 708 stored in the memory 706 and executed by the processor(s) 704. In some examples, the negotiation module 716 may be integrated within the processor(s) 704 and/or the transceiver(s) 710. For example, the negotiation module 716 may be implemented by a combination of software components (e.g., executed by a DSP or a general processor) and hardware components (e.g., logic gates and circuitry) within the processor(s) 704 or the transceiver(s) 710.

The negotiation module 716 may be used for various aspects of the present disclosure, for example, aspects of FIG. 5. The negotiation module 716 is configured to implicitly indicating UE subscription by including key ID and a SUPI in an EEC registration request, and determine a rejection reason from an EEC registration response. If the negotiation module 716 determines that the rejection reason was that an ECS requires a key ID, the negotiation module 716 may perform the corresponding procedure to fetch the key ID and send another EEC registration request with the key ID.

The network device 718 may include one or more processor(s) 720. The processor(s) 720 may execute instructions such that various operations of the network device 718 are performed, as described herein. The processor(s) 720 may include one or more baseband processors implemented using, for example, a CPU, a DSP, an ASIC, a controller, an FPGA device, another hardware device, a firmware device, or any combination thereof configured to perform the operations described herein.

The network device 718 may include a memory 722. The memory 722 may be a non-transitory computer-readable storage medium that stores instructions 724 (which may include, for example, the instructions being executed by the processor(s) 720). The instructions 724 may also be referred to as program code or a computer program. The memory 722 may also store data used by, and results computed by, the processor(s) 720.

The network device 718 may include one or more transceiver(s) 726 that may include RF transmitter and/or receiver circuitry that use the antenna(s) 728 of the network device 718 to facilitate signaling (e.g., the signaling 734) to and/or from the network device 718 with other devices (e.g., the wireless device 702) according to corresponding RATs.

The network device 718 may include one or more antenna(s) 728 (e.g., one, two, four, or more). In embodiments having multiple antenna(s) 728, the network device 718 may perform MIMO, digital beamforming, analog beamforming, beam steering, etc., as has been described.

The network device 718 may include one or more interface(s) 730. The interface(s) 730 may be used to provide input to or output from the network device 718. For example, a network device 718 that is a ECS may include interface(s) 730 made up of transmitters, receivers, and other circuitry (e.g., other than the transceiver(s) 726/antenna(s) 728 already described) that enables the ECS to communicate with other equipment in a core network, and/or that enables the ECS to communicate with external networks, computers, databases, and the like for purposes of operations, administration, and maintenance of the ECS or other equipment operably connected thereto.

The network device 718 may include a negotiation module 732. The negotiation module 732 may be implemented via hardware, software, or combinations thereof. For example, the negotiation module 732 may be implemented as a processor, circuit, and/or instructions 724 stored in the memory 722 and executed by the processor(s) 720. In some examples, the negotiation module 732 may be integrated within the processor(s) 720 and/or the transceiver(s) 726. For example, the negotiation module 732 may be implemented by a combination of software components (e.g., executed by a DSP or a general processor) and hardware components (e.g., logic gates and circuitry) within the processor(s) 720 or the transceiver(s) 726.

The negotiation module 732 may be used for various aspects of the present disclosure, for example, aspects of FIG. 5. The negotiation module 732 is configured to receive and respond to EEC registration requests as described with reference to FIG. 5.

Embodiments contemplated herein include an apparatus comprising means to perform one or more elements of the signal diagram 500. This apparatus may be, for example, an apparatus of a UE (such as a wireless device 702 that is a UE, as described herein). This apparatus may be, for example, an apparatus of an ECS (such as the network device 718, as described herein).

Embodiments contemplated herein include one or more non-transitory computer-readable media comprising instructions to cause an electronic device, upon execution of the instructions by one or more processors of the electronic device, to perform one or more elements of the signal diagram 500. This non-transitory computer-readable media may be, for example, a memory of a UE (such as a memory 706 of a wireless device 702 that is a UE, as described herein). This non-transitory computer-readable media may be, for example, a memory of an ECS (such as a memory 722 of a network device 718, as described herein).

Embodiments contemplated herein include an apparatus comprising logic, modules, or circuitry to perform one or more elements of the signal diagram 500. This apparatus may be, for example, an apparatus of a UE (such as a wireless device 702 that is a UE, as described herein). This apparatus may be, for example, an apparatus of an ECS (such as the network device 718, as described herein).

Embodiments contemplated herein include an apparatus comprising: one or more processors and one or more computer-readable media comprising instructions that, when executed by the one or more processors, cause the one or more processors to perform one or more elements of the signal diagram 500. This apparatus may be, for example, an apparatus of a UE (such as a wireless device 702 that is a UE, as described herein). This apparatus may be, for example, an apparatus of an ECS (such as the network device 718, as described herein).

Embodiments contemplated herein include a signal as described in or related to one or more elements of the signal diagram 500.

Embodiments contemplated herein include a computer program or computer program product comprising instructions, wherein execution of the program by a processor is to cause the processor to carry out one or more elements of the signal diagram 500. The processor may be a processor of a UE (such as a processor(s) 704 of a wireless device 702 that is a UE, as described herein). These instructions may be, for example, located in the processor and/or on a memory of the UE (such as a memory 706 of a wireless device 702 that is a UE, as described herein). The processor may be a processor of an ECS (such as a processor(s) 720 of the network device 718, as described herein). These instructions may be, for example, located in the processor and/or on a memory of the ECS (such as a memory 722 of the network device 718, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a user equipment (UE), the method comprising:
subscribing to one or more authentication mechanisms supported by the UE;
generating key identifiers for the one or more authentication mechanisms supported by the UE;
transmitting a request to an edge configuration server (ECS), the request comprising:
the one or more authentication mechanisms supported by the UE, and
the key identifiers to indicate to the ECS that the UE is subscribed to the one or more authentication mechanisms;
receiving a response to the request comprising an authentication mechanism selected by the ECS; and
initiating an authentication procedure using the authentication mechanism selected by the ECS.

2. The method of claim 1, wherein the request further comprises a Subscription Permanent Identifier (SUPI).

3. The method of claim 1, further comprising:
deriving an Authentication and Key Management for Applications (AKMA) anchor key (K_{AKMA}) with a Home Public Land Mobile Network, and
wherein one of the key identifiers included in the request is an AKMA Key Identifier (A-KID).

4. The method of claim 1, wherein for a generic bootstrapping architecture (GBA), the UE includes a corresponding key identifier Bootstrapping Transaction Identifier (B-TID) in the request.

5. The method of claim 1, further comprising receiving, from the ECS, a rejection if there is no shared mechanism between the UE and the ECS, wherein the rejection indicates no shared mechanisms.

6. The method of claim 1, further comprising receiving, from the ECS, a rejection if the request includes a first authentication mechanism without an associated key identifier, wherein the rejection indicates that the key identifiers are required.

7. The method of claim 6, further comprising performing a procedure to fetch the associated key identifier.

8. The method of claim 7, further comprising transmitting a new request to the ECS, the new request comprising the first authentication mechanism with the associated key identifier.

9. A method performed by an edge configuration server (ECS), the method comprising:
receiving a request from a user equipment (UE), the request comprising:
one or more authentication mechanisms supported by the UE, and
key identifiers that indicate that the UE is subscribed to the one or more authentication mechanisms;
determining from the request the one or more authentication mechanisms supported by the UE for which the UE is subscribed;
selecting an authentication mechanism to be used by the UE for access to an edge data network;
sending a response to the request from the UE, the response indicating the selected authentication mechanism; and
performing an authentication procedure with the UE using the selected authentication mechanism.

10. The method of claim 9, wherein the request further comprises a Subscription Permanent Identifier (SUPI).

11. The method of claim 10, further comprising routing a service operation to a Network Exposure Function (NEF) of a Home Public Land Mobile Network of the UE to obtain missing key identifiers based on the SUPI.

12. The method of claim 9, wherein one of the key identifiers included in the request is an Authentication and Key Management for Applications (AKMA) Key Identifier (A-KID).

13. The method of claim 9, wherein for a generic bootstrapping architecture (GBA), the request includes a corresponding key identifier Bootstrapping Transaction Identifier (B-TID).

14. The method of claim 9, further comprising generating and sending a rejection, if there is no shared mechanism between the UE and the ECS, wherein the rejection indicates no shared mechanisms.

15. The method of claim 9, further comprising generating and sending a rejection if the request includes a first authentication mechanism without an associated key identifier, wherein the rejection indicates that key identifiers are required.

16. The method of claim 15, further comprising updating configuration information for the ECS on a Home Public Land Mobile Network associated with the UE.

17. A user equipment (UE) comprising:
a processor; and
a memory storing instructions that, when executed by the processor, configure the UE to:
subscribe to one or more authentication mechanisms supported by the UE;
generate key identifiers for the one or more authentication mechanisms supported by the UE;
transmit a request to an edge configuration server (ECS), the request comprising:
the one or more authentication mechanisms supported by the UE, and
the key identifiers to indicate to the ECS that the UE is subscribed to the one or more authentication mechanisms;
receive a response to the request comprising an authentication mechanism selected by the ECS; and
initiate an authentication procedure using the authentication mechanism selected by the ECS.

18. The UE of claim 17, wherein the request further comprises a Subscription Permanent Identifier (SUPI).

19. The UE of claim 17, wherein the instructions further configure the UE to:
derive an Authentication and Key Management for Applications (AKMA) anchor key (K_{AKMA}) with a Home Public Land Mobile Network, and
wherein one of the key identifiers included in the request is an AKMA Key Identifier (A-KID).

20. The UE of claim 17, wherein for a generic bootstrapping architecture (GBA), the request includes a corresponding key identifier Bootstrapping Transaction Identifier (B-TID).

21-23. (canceled)
